(19) United States
(12) Patent Application Publication
(10) Pub. No.: US 2009/0046140 A1
(43) Pub. Date: Feb. 19, 2009

(54) Mobile Virtual Reality Projector

(75) Inventors: David Lashmet, Bainbridge Island, WA (US); Andrew T. Rosen, Lynnwood, WA (US); Joshua O. Miller, Woodinville, WA (US); Christian Dean DeJong, Sammamish, WA (US); Michael L. Schaaf, Bainbridge Island, WA (US); Randall B. Sprague, Hansville, WA (US)

Correspondence Address: MICROVISION, INC., 6222 185TH AVENUE NE, REDMOND, WA, 98052, US

(73) Assignee: MICROVISION, INC., Redmond, WA (US)

(21) Appl. No.: 12/134,731

(22) Filed: Jun. 6, 2008

Related U.S. Application Data
(63) Continuation-in-part of application No. 11/761,908, filed on Jun. 12, 2007.
Application No. 11/761,908 is a continuation-in-part of application No. 11/635,799, filed on Dec. 6, 2006.
Application No. 11/635,799 is a continuation-in-part of application No. 11/858,696, filed on Sep. 20, 2007.
(60) Provisional application No. 60/742,638, filed on Dec. 6, 2005.

(51) Int. Cl. H04N 13/04; H04N 9/31

(52) U.S. Cl. 348/51; 348/744; 348/E13.001; 348/E09.025

(57) ABSTRACT

A spatially aware apparatus includes a projector. Projected display contents can change based on the position, motion, or orientation of the apparatus. The apparatus may include gyroscope(s), accelerometer(s), global positioning system (GPS) receiver(s), radio receiver(s), or any other devices or interfaces that detect, or provide information relating to, motion, orientation, or position of the apparatus.

### RELATED APPLICATIONS

The present patent application is a Continuation-in-Part (CIP) of U.S. application Ser. No. 11/761,908, filed Jun. 12, 2007, which is a Continuation-in-Part (CIP) of U.S. application Ser. No. 11/635,799, filed on Dec. 6, 2006, which is a non-provisional application of U.S. provisional application Ser. No. 60/742,638, filed on Dec. 6, 2005, all of which are incorporated herein in their entirety by reference for all purposes. The present patent application is related to co-pending patent application Ser. No. 11/858,696, filed on Sep. 20, 2007.

### FIELD

The present invention relates generally to stereoscopic projection devices, and more specifically to mobile stereoscopic projection devices.

### BACKGROUND

Stereoscopic projection systems are commonly in use in simulation environments and in multimedia entertainment systems. For example, dedicated virtual reality rooms are made using stereoscopic projectors for medical, military, and industrial applications. Also for example, many theatres are installing stereoscopic projectors to show stereoscopic motion pictures. As with many other devices, stereoscopic projectors are shrinking in size, their power requirements are reducing, and they are becoming more reliable.

### BRIEF DESCRIPTION OF THE DRAWINGS

FIG. 1 shows a mobile virtual reality projection apparatus;

FIG. 2 shows a mobile virtual reality projection apparatus;

FIG. 3 shows a mobile virtual reality projection system with various inputs and outputs;

FIG. 4 shows a mobile virtual reality micro-projector;

FIG. 5 shows the cubic area of a mobile virtual reality projection;

FIG. 6 shows monocular and stereoscopic images of an object in motion;

FIG. 7 shows a sensorium created by a mobile virtual reality projection apparatus;

FIG. 8 shows a microcosm displayed by a mobile virtual reality projection system;

FIG. 9 shows a mobile virtual reality projection gaming apparatus;

FIG. 10 shows a mobile virtual reality projection apparatus used as an aid to navigation;

FIG. 11 shows a spatially aware mobile projection system used as a medical information device;

FIG. 12 shows a vehicular mobile virtual reality projection apparatus; and

FIGS. 13 and 14 show flowcharts in accordance with various embodiments of the present invention.

### DESCRIPTION OF EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

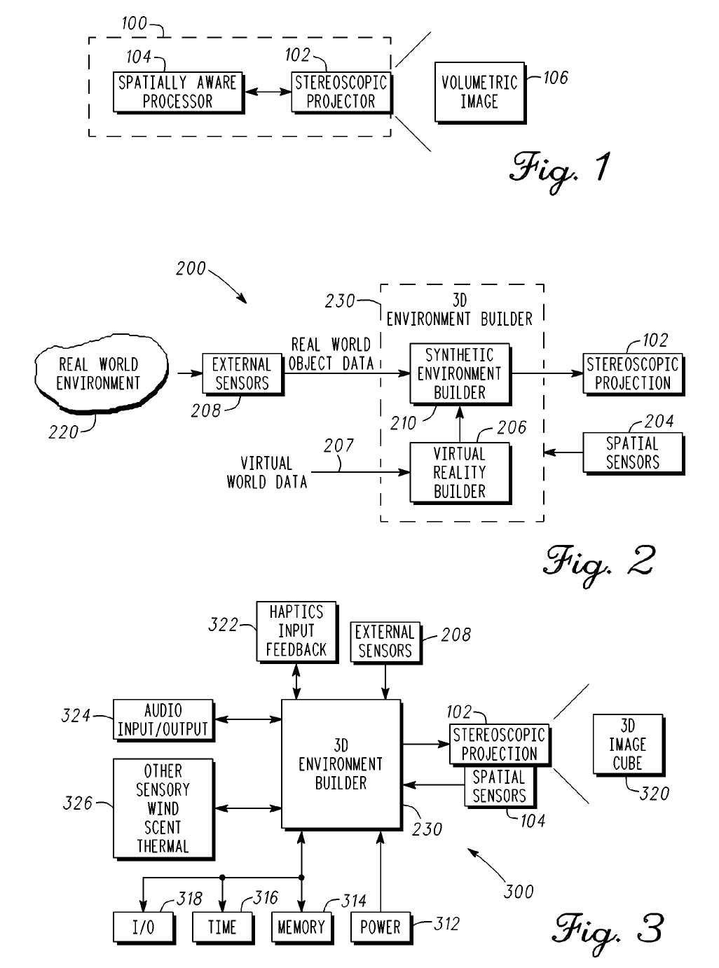

FIG. 1 shows a mobile virtual reality projection apparatus. Mobile projection apparatus 100 includes stereoscopic projector 102 and processor 104. Projector 102 projects a volumetric image 106. Processor 104 has information relating to the spatial position, orientation, and/or motion of apparatus 100, and is referred to as being “spatially aware.” The term “spatially aware” describes access to any information relating to spatial characteristics of the apparatus. For example, as described above, a spatially aware processor within an apparatus may have access to information relating to the position, motion, and/or orientation of the apparatus.

Projector 102 may change the projected image in response to information received from processor 104. For example, processor 104 may cause projector 102 to modify the image in response to the current position of apparatus 100. Further, processor 104 may cause projector 102 to modify the image in response to motion of the apparatus. Still further, processor 104 may cause projector 102 to modify the image in response to a current orientation or change in orientation of the apparatus. In some scenarios, processor 104 may recognize the spatial information without changing the image. For example, processor 104 may change the image in response to spatial information after a delay, or may determine whether to change the image in response to spatial information as well as other contextual information.

Processor 104 may obtain spatial information and therefore become spatially aware in any manner. For example, in some embodiments, apparatus 100 may include sensors to detect position, motion, or orientation. Also for example, the position/motion/orientation data may be provided to apparatus 100 through a wired or wireless link. These and other embodiments are further described below with reference to later figures.

In some embodiments, processor 104 provides image data to projector 102, and changes it directly. In other embodiments, image data is provided by a data source other than processor 104, and processor 104 indirectly influences projector 102 through interactions with the image data source. Various embodiments having various combinations of image data sources are described further below with reference to later figures.

Projector 102 may be any type of stereoscopic projector suitable for inclusion in a mobile apparatus. In some embodiments, stereoscopic projector 102 includes two small, light, battery-operated projectors. For example, projector 102 may include micro-electro mechanical system (MEMS) based projectors having an electromagnetic driver that surrounds a resonating aluminum-coated silicon chip. The aluminum coated silicon chip operates as a small mirror (“MEMS mirror”) that moves on two separate axes, x and y, with minimal electrical power requirements. The MEMS mirror can reflect light as it moves, to display a composite image of picture elements (pixels) by scanning in a pattern. Multiple laser light sources (e.g., red, green, and blue) may be utilized to produce color images.

The two MEMs based projectors produce left and right display images that when combined form a stereoscopic image. For example, the left display image may be presented and/or occluded in such a way that it is only visible by a viewer's left eye, and the right display image may be presented and/or occluded in such a way that it is only visible by the viewer's right eye. This may be accomplished in many ways, including polarization of the left and right display images or the use of shutter glasses.

In some embodiments, projector 102 includes one MEMS based projector that display both left and right display images. The left and right display images may be orthogonally polarized to allow a viewer to distinguish between them. The left and right display images may also be separated in time to allow a viewer to distinguish them. For example, even numbered display frames may be polarized for the left eye, and odd numbered display frames may be polarized for the right eye. In this manner, the left and right display images are interlaced in a video stream produced by a single projector.

The combination of a spatially aware processor and a stereoscopic projector allow apparatus 100 to adjust the displayed 3D image based at least in part on its location in time and in space. For example, the displayed 3D image can change based on where the apparatus is pointing, or where it is located, or how it is moved. Various embodiments of spatially aware 3D projection systems are further described below.

Mobile virtual reality projection systems may be utilized in many applications, including simulators, gaming systems, medical applications, and others. As described further below, projected 3D images may be modified responsive to spatial data alone, other input data of various types, or any combination. Further, other output responses may be combined with a dynamic image to provide a rich user interaction experience. In addition, an apparent inter-ocular distance between left and right display images may be modified.

FIG. 2 shows a mobile virtual reality projection apparatus. Mobile virtual reality projector apparatus 200 includes stereoscopic projector 102 combined with various motion, position and/or orientation sensors (“spatial sensors”) 204. Mobile virtual reality apparatus 200 also includes external sensors 208 and 3D environment builder 230, which in turn includes synthetic environment builder210 and virtual reality builder 206.

In operation, 3D environment builder 230 “builds” a stereoscopic image to be sent to projector 102. Left and right display images that when combined form a stereoscopic image are built using data that represents a virtual world as well as data that represents real world objects. Further, the stereoscopic image can change based on information provided by spatial sensors 204.

Virtual reality builder 206 is responsive to virtual world data provided at 207 and is also responsive to spatial sensors 204 and changes stereoscopic images to be sent to projector 102 as necessary. The virtual world data represents visual characteristics of virtual objects to be displayed by stereoscopic projector 102. For example, the virtual world data may represent characters or background scenery in a simulated environment. In some embodiments, the virtual world data is stored statically, such as in a read-only memory. In other embodiments, the virtual world data is provided dynamically from an outside source.

External sensors 208 detect characteristics of real objects in real world environment 220. For example, sensors 208 may sense the size, shape, and color of real objects or subjects, and/or parts of subjects such as hands in the field of view of projector 102. External sensors 208 may include one or a plurality of the following digital or electronic sensors that can detect real world objects in three dimensions: microphones or directional microphones; visual spectrum or other electromagnetic position detectors; radioactive, chemical, temperature sensors, or the like. Alternatively, external sensors 208 may be attached to a remote device, such as a virtual reality glove, and communicate to synthetic environment builder 210 by wired or wireless means. In this case, external sensors 208 may include motion, position or orientation sensors such as accelerometers, gyroscopes, digital compasses, GPS receivers, pressure sensors, and the like.

Synthetic environment builder 210 is responsive to external sensors 208 and also responsive to the various motion, position and orientation sensors 204 that track the spatial characteristics of stereoscopic projector 102. Synthetic environment builder 210 synthesizes the real world data with the stereoscopic images provided by virtual reality builder 206, and changes the stereoscopic images sent to projector 102 as necessary.

Accordingly, 3D environment builder 230 produces stereoscopic images that combine representations of virtual objects and real world objects. In some embodiments, real world objects in the field of view replace virtual objects occupying the same space. This incorporates real world objects in the virtual world experience. In other embodiments, real world objects are translucent in the virtual environment, and in still other embodiments, real world objects are shown as outlines in the virtual environment. Any video processing techniques may be utilized in the synthesis of real and virtual objects without departing from the scope of the present invention.

In some embodiments, sensors 208 are not included, or are not operational. In these embodiments, 3D environment builder does not synthesize the real world data and virtual world data. Instead, the stereoscopic images produced by virtual reality builder 206 are provided directly to projector 102.

3D environment builder 230 may be implemented in hardware, software, or any combination capable of rendering a virtual environment with three dimensions: width, depth, and height. For example, in some embodiments, 3D environment builder 230 includes software modules running on a processor such as spatially aware processor 104 (FIG. 1). Also for example, 3D environment builder 230 may include a central processor, any number of graphics cards, any number of physics cards, computer memory, and the software capable of generating images for display by stereoscopic projector 102. In still further examples, 3D environment builder may be implemented in special purpose hardware such as an application specific integrated circuit (ASIC).

3D environment builder 230 is responsive to the data collected from motion, orientation, and/or position sensors 204. When the software dictates changes to the virtual environment based on these data inputs, 3D environment builder 230 alters the images sent to stereoscopic projector 102. This “responsive to movement” feature of 3D environment builder 230 is designed to maintain the illusion of virtual reality.

Mobile virtual reality projection apparatus 200 may be self-contained, or its various components may be connected by wire or by wireless means. For example, the stereoscopic projector 102 and various motion, position and/or orientation sensors 204 may be contained in a single apparatus, with the 3D environment builder 230 connected to this apparatus by wire or wireless means. In this example, external sensors 208 may be part of the apparatus containing stereoscopic projector 102 and motion, position and/or orientation sensors 204. In a third example, external sensors 208 are connected to the apparatus containing stereoscopic projector 102 and motion, position and/or orientation sensors 204 by wire or wireless means.

Stereoscopic images displayed by stereoscopic projector 102 may be produced in any of several ways, including red/green or red/cyan anaglyphs; alternately exposing the displayed images frame by frame between the observer's left and right eyes using shutter glasses; using orthogonally polarized images simultaneously; or auto-stereoscopically.

Motion, position and orientation sensors 204 may include one or a plurality of the following digital or electronic sensors: accelerometers, gyroscopes, digital compasses, speedometers, odometers, Global Positioning Satellite (GPS) or Galileo constellation positional receivers, other wireless proximity signals received via WirelessHD, Radio, Bluetooth, WiFi, WiMax, or Cellular transmission; pressure sensors; microphones or directional microphones; visual spectrum or other electromagnetic position detectors; radioactive, chemical, temperature sensors, or the like.

Motion, position and orientation sensors 204 typically have recourse to a clock, to account for stability or change over time. Such a clock may be integral to the motion sensor(s), integral to 3D environment builder 230, integral to the stereoscopic projector 102, or located outside the mobile virtual reality projection apparatus 200, via a wire or wireless connection. In other embodiments, this clock may be integral to or be detected by external sensors 208.

Stereoscopic projectors display vastly richer data sets than monocular (2D) projectors, if the observer has binocular vision. Principally, binocular vision provides an observer with depth perception, binary summation, and relative motion parallax. There are many additional benefits related to binocular vision known to experts in the field, including saccade, micro-saccade and head movement enhancements to simple binocular depth perception. For any given resolution, then, stereoscopic projectors deliver more to see.

Stereoscopic projector 102 also enhances utility. Far beyond idle observation, human vision also establishes balance, including equilibrium and body position awareness. Binocular vision in particular helps map a human body in space with respect to other objects. Further, this balance and referential mapping helps coordinate intentional movement, including hand-eye actions, foot-eye actions, dodging blows, tumbling, climbing, high-diving, etc. Multisensory benefits also accrue to human spatial awareness, balance and intentional movement. This is explained further below.

FIG. 3 shows a mobile virtual reality projection system with various inputs and outputs. System 300 includes stereoscopic projector 102, sensor 204, 3D environment builder 230, and optional external sensors 208, as described above with reference to FIG. 2. Thus, the apparatus depicted in FIG. 3 may create a virtual reality or a synthetic reality, as determined by external sensors 208, and mediated by the synthetic reality builder within 3D environment builder 230. If there is no data from external sensors 208, the displayed images comprise a virtual reality. If there is data delivered from external sensors 208 to 3D environment builder 230, the displayed images comprise a synthetic reality. Three other optional input and output controls may be included: haptics interface 322, audio interface 324, and other sensory interfaces 326.

3D image cube 320 represents the image displayed by stereoscopic projector 102. 3D image cube 320 therefore offers observers the benefits of binocular vision as described above with reference to FIG. 2. Note that 3D image cube 320 is an illusionary space in the case of a virtual reality projection, and a partially illusive space in the case of synthetic reality projection. The image is described as a cube because a stereoscopic projection is typically an overlapping pair of two-dimensional, rectangular video frames or pictures produced by a digital projector or projectors. In the case of some laser powered stereoscopic projectors with infinite focus, there is no necessity for a flat, two dimensional display surface. Instead, such a display field can be curved, textured, etc. Nevertheless, with respect to the observer(s), the displayed images contain the depth cues of the stereoscopic projection. Thus, the shape space can be defined up to the limits of an illusionary cube, regardless of the geometry of the display surface.

Haptic interface 322 allows for somatic interaction between a user and the mobile virtual reality projector. Haptic inputs from the user such as manipulation of dials, buttons, joysticks, step pads, pressure sensors, etc., are treated as directional controls or functional instructions by the 3D environment builder 230. Such haptic inputs may supplement or detract from inputs given by spatial sensors 204 and/or external sensors 208. Haptic outputs include vibrations, shakes, rumbles, thumps, or other electro-mechanical stimulus from the mobile virtual reality projector to the user. Such haptic outputs are controlled by the 3D environment builder 230.

Audio interface 324 allows for auditory interaction between a user and the mobile virtual reality projector. Audio inputs from the user such as verbal instructions or humming or whistles, etc, are treated as directional controls or functional instructions by the 3D environment builder 230. Additional processing such as voice stress analyzing, voice identification, tune matching, etc. may also be employed. These sorts of audio inputs may supplement or detract from inputs given by spatial sensors 230 and/or external sensors 208. Outputs from audio interface 324 may include recorded or synthesized voices or sounds of any perceptible frequency. Such audio outputs are controlled by the 3D environment builder 230.

Additional sensory interface 326 allows for other sorts of somatic or sensory interaction between a user and the mobile virtual reality projector. Additional sensory inputs from the user such as chemical odors or thermal signatures or fingerprints, etc., are treated as directional controls or functional instructions by the 3D environment builder 230. These various sorts of user inputs may supplement or detract from inputs given by spatial sensors 204 and/or external sensors 208. Outputs from additional sensory interface 326 may include wind machine, scent, thermal or similar technologies sensible to a user. Such sensory outputs are controlled by the 3D environment builder 230.

Haptics, sound, and other sensory user/machine interactive devices strongly supplement the sensation of a virtual or synthetic environment. For example, haptic user interface 322 supports hand-eye coordination, and therefore the manipulation of real or virtual objects. In humans, hand-eye coordination typically involves binocular vision. For example, a simple reach gesture may involve rapidly scanning ahead, moving a hand, and then looking again to complete the grasp. Because of relative motion parallax, depth perception and binary summation, such manual tasks are made easier with binary vision. And the same is true for hitting a baseball, or threading a needle. Put simply, multisensory feedback makes any virtual or synthetic world seem more real.

For objects beyond human reach, sound is a key sensory clue that supplements binary vision. Natural sounds emanate from discrete locations in space and time, and audio interface 324 can mimic these sounds by stimulating a user's binaural hearing. Normal-hearing individuals can recognize the differences in pitch, timing and amplitude of sounds sensed by each ear, and use these differences to cognitively map the sound sources by distance and direction. Such auditory skills naturally enhance binary vision, or substitute for vision in darkness or beyond one's field of view. Therefore, binaural or “surround-sound” headphones that create a virtual auditory environment are useful additions to a mobile virtual reality projection system.

Other human senses are less commonly stimulated in digitally-created environments, but multisensory inputs 326 may increase the user's belief in a mobile virtual reality projector system. For example, small fans that can simulate violent explosions or gentle breezes are commercially available accessories for video gaming systems. Such small fans may be incorporated into a mobile virtual reality projector system to reinforce a stereoscopic projection of a user moving forward. Also for example, fragrances or artificial scents can be used to support digitally-created artificial vistas, such as fields of flowers.

In addition, devices such as a mobile virtual reality projector system require a source of electricity, whether this is generated internally, stored in batteries, or drawn off an electrical grid. Power source 312 assumes any of these methods, or their combination, such as rechargeable batteries, or hand-powered generators with back-up batteries.

In a similar vein, the 3D environment builder 230 may require access to electronic memory 314, timing clocks 316 and input/output (I/O) circuits 318. Such electrical components may be wired directly to the mobile virtual reality projector, or they may be connected with removable wires, or connected wirelessly.

Memory 314 represents any digital storage component. For example, memory 314 may be an embedded storage device, such as a hard drive or a flash memory drive, or removable storage device, such as an SD card or MicroSD card. In some embodiments, memory 314 is a source of display data for projector 102. Also in some embodiments, memory 314 stores instructions that when accessed by a processor result in the processor performing method embodiments of the present invention. For example, memory 314 may store instructions for software modules that implement all or part of 3D environment builder 230.

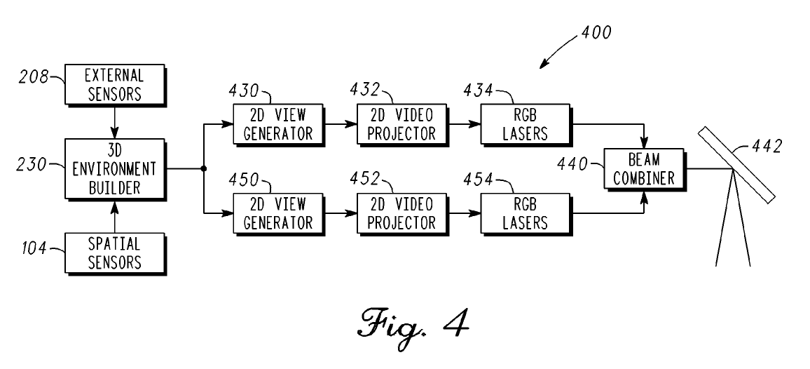

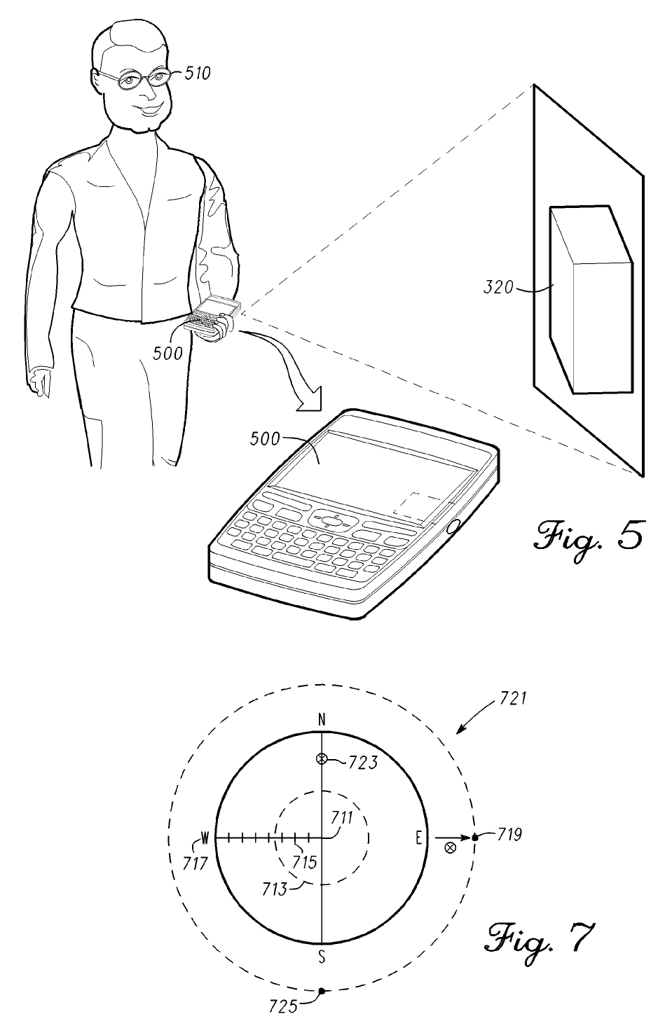

FIG. 4 shows a mobile virtual reality micro-projector. Stereoscopic projector 102 may be any type of stereoscopic or auto-stereoscopic projector suitable for inclusion in a mobile apparatus. Note that this projector component may include one or a plurality of projectors that combine to create a stereoscopic image.

As part of a mobile virtual reality projection system, the referenced stereoscopic projector works as follows: Spatial sensors 104 supply data on the position, orientation and/or motion of the apparatus to 3D environment builder 230. External sensors 208 also capture data from the real world for 3D environment builder 230. Based on this data and its operational logic, 3D environment builder 230 creates a pair of two-dimensional visual scenes 430, 450, for the right and left eyes of the observers, respectively, in order to simulate natural binary vision. Each two-dimensional visual scene is delivered to a two-dimensional video projector 432, 452, for display. In this example, each video projector drives red, green and blue lasers 434, 454 to produce an image pixel-by-pixel. These two beams of pixel-encoded laser light are combined by a beam combiner 440, and aimed at the scanning MEMS mirror 442 for projection.

In other embodiments, a mobile virtual reality projection system may be constructed using one or a plurality of small digital projectors that can deliver video picture frames at a rapid rate (for example, 40 frames per second or higher). In this case, the observers require eyewear that shunts alternating video frames to right and left eyes, to simulate binary vision. Such eyewear must be synchronized with the projector, as the left eye must be covered while the right eye is uncovered, and vice versa. This sort of electrically occluded eyewear is known as a pair of shutter glasses. Shutter glasses typically rely on liquid crystal technology, although other sorts of electrical, chemical or mechanical shuttering are also possible.

Some stereoscopic MEMS projectors do not require shutter glasses, if the two laser beams have opposite polarizations. In this case, observers wear glasses or contact lenses with oppositely polarized filters for the right and left eyes. This sort of polarized eyewear need not be synchronized to the projector. However, the screen where the projection lands must retain the proper polarizations, to preserve the polarized nature of the two beams. In other words, a stereoscopic MEMS projector may require special screening material, whereas a fast refresh rate projector does not. Different user case scenarios will find advantages to each approach. And auto-stereoscopic projectors may have alternative advantages. For these reasons, the current invention does not limit what sort of stereoscopic projector 102 is used in the mobile virtual reality projection system.

The two 2D images created by system 400 have an “apparent inter-ocular distance.” The apparent inter-ocular distance refers to the distance between the sensors that created the image. For example, if the image represents the normal perspective of a human, the apparent inter-ocular distance corresponds to the distance between a pair of human eyes. The various embodiments of the present invention are not limited to an apparent inter-ocular distance corresponding to the human inter-ocular distance. For example, the two images can be created with an apparent inter-ocular distance much greater than the human inter-ocular distance, thereby allowing for significantly greater depth perception. In some embodiments, the apparent inter-ocular distance is modified based on spatial characteristics of the mobile virtual reality projection apparatus. For example, movement of the apparatus may be interpreted as a command to increase or decrease the apparent inter-ocular distance, and the generated 2D images may be modified accordingly.

FIG. 5 shows the cubic area of a mobile virtual reality projection. Mobile virtual reality projection apparatus 500 may be any of the projection apparatus embodiments described herein. Projection apparatus 500 projects light from a small stereoscopic or auto-stereoscopic projector. Such stereoscopic projections are based on pairs of images, so that half of the images are seen by the right eyes of the observers, and the other half of the images are seen by the left eyes. These images may be referred to as “left images” and “right images.” These stereo images are coded for display as if they had three dimensions, but the images themselves are two-dimensional. It is the perception of these images by the right and left eyes of the observers which give the appearance of the third dimension: depth.

In this sense, 3D image cube 320 is virtual: although this can be recognized by prepared observers, the perceived depth is an optical illusion. Strictly speaking, this recognition takes place as a chain of ocular and neurological events, starting in the human retina, passing through the optic nerve to the brain's primary visual cortex, and beyond. Yet because multiple observers can see the same stereoscopic projections, it's not simply a figment of one person's imagination, but rather a shared illusion, and thus a shared visual space.

Furthermore, mobile virtual reality projection apparatus 500 does project photons in the visible spectrum. So there is measurable energy from the stereoscopic or auto-stereoscopic projector to the surface or surfaces where the image lands. Thus, there is a cone or pyramid of light filling a space. But in the case of a rear projection, the 3D image cube 320 and the pyramid or cone of light are not co-extant. Therefore, it is simplest to consider 3D image cube 320 as a virtual space.

In the case of an auto-stereoscopic projector, observers can recognize the bilateral images without intervening optics. But intervening or decoding optics 510 are necessary in the cases of color filtered stereo projections, orthogonally polarized stereo projections, circularly polarized stereo projections, and quickly alternating stereo projections. Decoding optics 510 may take a variety of forms, from helmet or head-band mounted eyepieces to glasses, or even contact lenses for circular polarized stereoscopic images. Further, decoding optics 510 may include chromatic filters, polarized filters, or liquid crystal shutter glasses. Decoding optics 510 may be at least partially transmissive of light—either over time or over part of their surface area. This allows objects with apparent depth to appear distant from the viewer. In this fashion, there is no sensory mismatch between where an observer's eyes are pointed, and what he or she sees.

By contrast, so called “virtual reality” glasses typically comprise a pair of organic light emitting diode (OLED) panels, liquid crystal display (LCD) panels, or the like mounted to eyewear or to headgear. With such occluded display panels, apparently distant objects are very close to the observer's eyes, and the eyes recognize this, and converge. This difference between the eyes' natural vergence and their artificial focal point leads to “virtual reality headaches,” and ultimately motion sickness.

A further benefit of transmissive decoding optics 401 is that an observer's head position and body position are consistent with the visual frame of reference. Thus, the human vestibular, gravitational and proprioception senses are aligned with the images seen by the visual cortex. This supports natural human balance and equilibrium, and thus an acceptable virtual reality experience. By contrast, virtual reality display technologies which can introduce a sensory mismatch between the visual scene and head position, body position or gravity quickly lead to motion sickness.

Some varieties of decoding optics 510 have additional advantages in mitigating motion sickness. For example, circularly polarized decoding optics retain the stereoscopic aspect of circularly polarized images even if an observer's head is tilted to the right or left, with respect to 3D image cube 320. Also for example, polarized decoding optics do not flash and occlude alternate eyes, like shutter glasses. As a consequence, polarized 3D technologies do not introduce the flicker vertigo that some people experience while wearing shutter glasses. However, because polarized decoding optics require a display screen that maintains the polarization of the projection, while shutter glasses do not have this requirement, both decoding approaches have utility. The present invention is not limited by the type of decoding optics utilized.

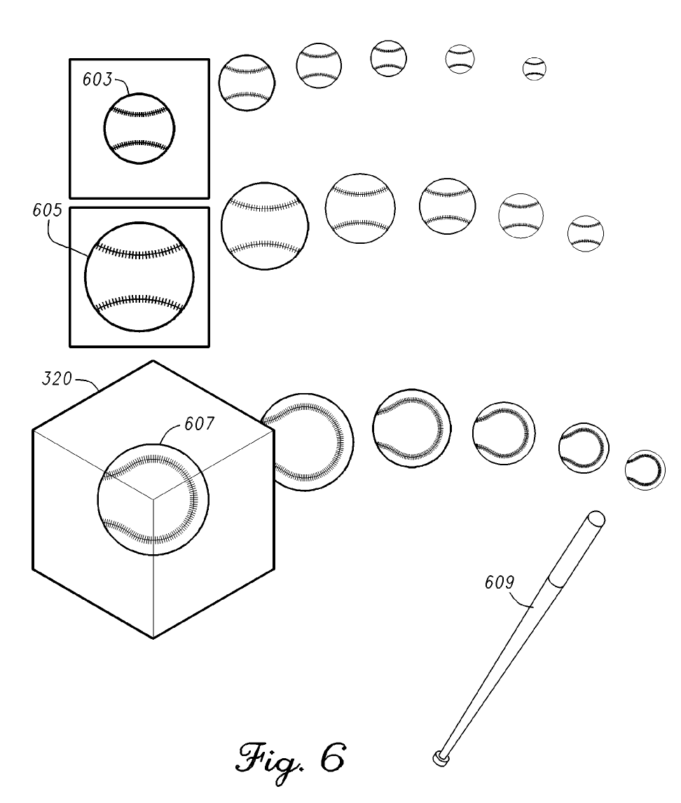

With all transmissive decoding optics 510, there is a clear advantage over near-to-eye, occluded virtual reality displays in terms of preventing vergence/accommodation conflict. So, either in the case of auto-stereoscopic projections or stereoscopic projections with transmissive optics, mobile virtual reality projection apparatus 500 produces a virtual reality environment in 3D image cube 320 consistent with a human's sense of balance. Maintaining one's balance has clear advantages in virtual or synthetic environments where the observer desires to move. One example of such human movement in virtual or synthetic space is described with reference to FIG. 6.

FIG. 6 shows monocular and stereoscopic projections of an object in motion. For observers watching and potentially interacting with small baseball 603, the apparent distance of this object is primarily based on its placement relative to other objects in the frame, its changing size relative to its perceived motion and the results of interactions between the observer and/or projector movement.

In a video game where the goal would be swinging a bat 609, in a conventional 2D projection, a user would learn the timing for missing or successfully hitting the baseball based on the aforementioned factors. However given the lack of stereoscopic depth perception or relative motion parallax, if the game were to randomly use a larger baseball 605 in place of small baseball 603, the learned timings would result in a miss since the major cue is based on the relative size of the ball at the correct time and the larger baseball 605 would in fact be further away at the time for a swing at small baseball 603.

As shown, a larger or smaller object gives false clues when measured against the learned environment. In a similar fashion, changes in the projection environment, observer to surface, projector to surface, etc., would also change the timings involved since they could affect the perceived size of the object in the projected environment even without changes inside the projected environment. This limits the nature, scope and enjoyment of applications where this sort of interaction is needed and a learning curve exists to understand the relationships between objects.

In this embodiment, as spherical baseball 607 appears to approach the observer, the spherical baseball will increase in size like the change seen with small baseball 603 and larger baseball 605, but the addition of relative motion parallax and binocular depth perception means that an observer gets additional information about the actual size of the baseball from the disparate left and right images generated by stereoscopic project 102. As a result the size of the approaching object can change but an observer can sense and adjust for that change based on the additional senses that stereoscopic data enables.

One real world example of this is seen in Major League Baseball where premier hitters close their dominant eye during batting practice. This builds the focus and motion tracking kinematics of their non-dominant eye. During games those hitters use both eyes and gain maximum advantage from relative motion parallax and stereoscopic depth perception.

FIG. 7 shows a sensorium 721 created by a mobile virtual reality projection apparatus. A sensorium is the classical term for the seat of sensation in the mind. In neurological terms, this sensorium would be located in the brain, and arguably the eyes, retinas, retinal nerves, cochlear nerves, etc. The mobile virtual reality projection apparatus to within the limits of technology, stimulates the sensorium identically as the real world stimulates the sensorium.

This sort of created virtual reality is distinct from dreams in part because it is programmed, and reproducible. But experiences in a virtual reality environment are also a sort of fiction, because the objects are phantasms, even though the subjects are real. Meanwhile, synthetic environments include some real objects, which make them partially dream-like, and partially real. So the best way to define this experiential space is according to the limits of perception by its participants. For simplicity's sake, this perceptually-limited experiential space will be called the sensorium 721.

Recreating the sensorium 721 requires engineering. For example, creating believable images requires display hardware, simulation software, and their interaction. In terms of visual displays, such technical considerations as native resolution, contrast ratio, focus, field of view, color palette, frame refresh rate, flicker, and the vergence/accommodation conflict all matter. In software, credible simulations are achieved through artificial intelligence, graphics rendering, and advanced physics calculations. After combining display hardware and simulation software, the quality of sensorium 721 can be affected by navigational accuracy, system latency, and the encumbrance of the apparatus. As a consequence, the mobile virtual reality projection apparatus is an advanced computational and optical device, even though it's potentially battery operated, inexpensive, and portable.

Within sensorium 721, there is an observer 711 who can look in any direction that is illuminated by the mobile virtual reality projection apparatus in order to perceive the stereoscopic projection. For example, observer 711 may use a mobile virtual reality projection apparatus like a handheld flashlight, or attached to the observer's head like a miner's lamp. Also for example, multiple projectors may be used in order to expand the horizontal and/or vertical field of view. For clarity, sensorium 721 is drawn as a circle, but in practice, it is a boundless three dimensional space. Thus, any reference in the following detailed description to horizontal orientations apply equally to the vertical realm. For instance, observer 711 may look up into a virtual canopy of trees, or down into a virtual canyon. The same vertical sense perception within Sensorium 721 applies equally to sound, touch, scent, wind effects, etc.

Projectors require surfaces onto which they can be displayed, and projection surface 713 marks the physical limit of the virtual or synthetic environment, even though the sensorium 721 extends far beyond this barrier. In the current example, projection surface 713 is an opaque white plastic sheeting that coats the inside of a freestanding dome. Many other projection surfaces are equally suitable, including painted white walls in a rectangular room; high gain motion picture projection screens arranged in a cube; sheeting that retains polarization attached to the floor and ceiling, and draped in a cylindrical shape to cover the cardinal directions, etc. Yet a sphere remains the exemplary case, because it has neither beginning nor end, and circumscribes three-dimensional space.

In this example, the freestanding dome is a hemisphere, with a diameter of six meters. Observer 711 standing in the center of the dome and therefore at the center point of the projection surface 713 can not reach this surface without stepping. Touchstone point 715 marks the practical limit of direct physical interaction between real or virtual objects and observer 711. Typically, touchstone point 715 is within two meters of observer 711, although exceptions are possible. What matters in this example is that projection surface 713 is beyond touchstone point 715, and, as stated above, sensorium 721 extends further from observer 711 than projection surface 713 does.

Primarily, this is because sensorium 721 may include images of apparently distant objects that observer 711 can display onto projection surface 713 using a mobile virtual reality projection apparatus. For example, a mobile virtual reality projection apparatus could project an image of the Washington Monument as seen from the far side of the reflecting pool at the National Mall in the District of Columbia, Md., United States. Such apparently distant objects are convincingly displayed if projector resolution, contrast, color palette, artificially created cloud cover, shadows, etc., meet or exceed a user's expectations.

Mobile virtual reality projection apparatus of the present invention are an improvement over spatially aware mobile projectors because of the myriad sensory and multi-sensory benefits of stereoscopic projection. For example, stereoscopically-displayed virtual objects that are apparently within ten meters of observer 711 can be precisely mapped and tracked using depth perception cues. By contrast, with monocular flat panel displays and projections, virtual objects can only be located by relative position, and because they lack depth, such objects look like defective imitations to human observers. In the present invention, near-field point 717 marks the ten meter radius sphere within sensorium 721 where virtual objects that are displayed stereoscopically will have apparent depth, and will be perceived as real objects by observer 711.

Sound cues created by a mobile virtual reality projection apparatus can supplement human depth perception, and expand sensorium 721. For example, if observer 711 is facing near-field point 717, which is positioned to the west in this bird's eye view diagram of sensorium 721, a noise apparently emanating from east sound point 719 is behind the observer. Thus, sensorium 721 is a sphere, not a hemisphere. Further, if the noise at east sound point 719 provides sound position cues to human observers, this can expand the spherical area where sensorium 721 gives measurable depth information. Such positional cues can be delivered via stereophonic, quadraphonic, surround sound, or any similar technology. What is essential that these cues are perceived by both ears of observer 711. Thus, east sound point 719 may seem to be further away than the ten meter radius of human depth perception, but humans can localize sounds past this ten meter limit. In this case, sensorium 721 extends beyond near-field point 717.

In another example, south sound point 725 apparently emanates from beyond human limits to localize sound or to perceive depth. However, apparently distant sounds still can contribute to the quality of the simulation experienced by observer 711. For example, if a bolt of lightning appeared at south sound point 725, and this flash was followed four seconds later by the sound of thunder, observer 711 could recognize that a virtual storm front was at least half a mile away. In this case, sensorium 721 has an apparent diameter of one mile. Such time delays between sight and sound work for many additional simulated scenes, at various distances. For example, a simulation where trees are felled in advance of a forest fire, or a jet streaks above the observer, followed by a sonic boom. In both additional cases, sensorium 721 extends beyond near-field point 717.

Sound cues can also enrich the visual images created by a mobile virtual reality projection apparatus to create a more believable experience. For example, a noise apparently emanating from north sound point 723 may be within human sound localization distance and the ten meter radius of human depth perception, for more precise multi-sensory mapping. Furthermore, the noise can include tonal elements, reverberation and/or resonance that reinforces the visual scene. For example, the noise apparently emanating from north sound point 723 may be the sound of a violin, where the rhythm of the music matches the apparent movement of the violin's bow across the strings. To further this example, the reverberation of this violin music may help observer 711 believe the experienced scene is within an enclosed space, such as the US National Cathedral. Such multisensory stimuli are extremely convincing to human observers.

In practical terms, there is no limit to the richness of sensorium 721. By adding tactile, acoustic, wind and/or olfactory outputs to the visually displayed scene, the various mobile virtual reality projection apparatus embodiments can saturate a human's multi-sensory perception. Further, because the mobile virtual reality projection apparatus of the present invention lets observer 711 retain normal human balance and equilibrium, the observer's hidden sixth sense is also coordinated with the visually displayed scene. In some embodiments of virtual reality projection apparatus, the displayed images have no flicker. And in all embodiments, there is no conflict between ocular vergence and accommodation. Thus, based on the quality of simulation software, the number and resolution of projectors, the number and fidelity of acoustical speakers, etc., the various mobile virtual reality projection apparatus of the present invention can create experiences that are potentially indistinguishable from the real world.

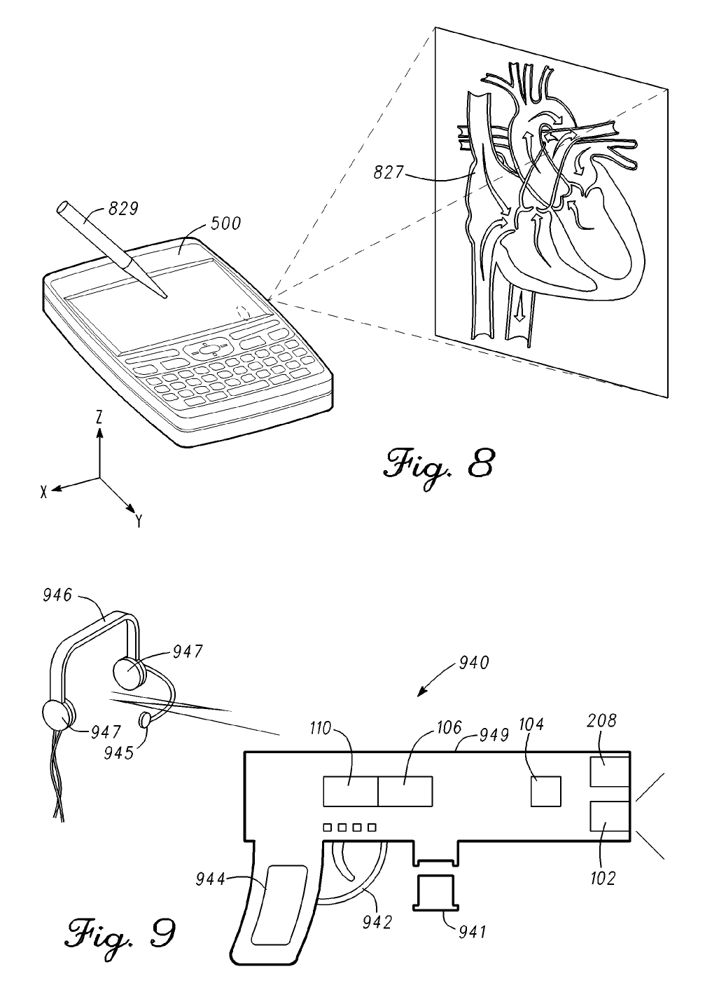

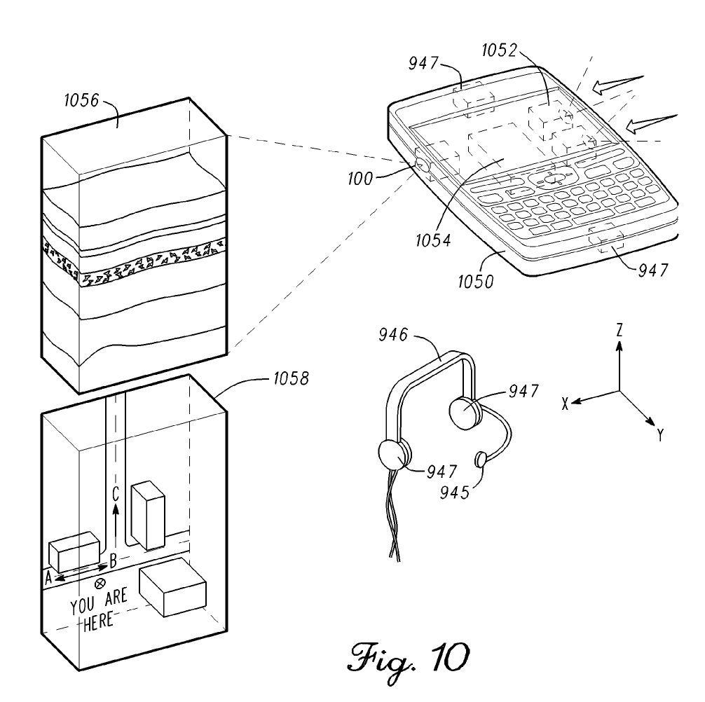

FIG. 8 shows a microcosm displayed by a mobile virtual reality projection system. Rather than being defined by the maximum extent of a simulation, like the sensorium described in FIG. 7, microcosm 827 is a miniature world, and the observer is outside of it.

For example, microcosm 827 can be the stereoscopic projection of a life-sized human heart. Naturally, such a projection can be magnified or minimized, if the observer moves the mobile projector further from or closer to the display screen, respectively. Such magnifications to microcosm 827 can also be accomplished through other commands by the observer, automatically changed by a software program, etc.

Stereoscopic microcosm 827 can be a static image or an animated one: for example, a beating heart that moves in three dimensions. Such a moving stereoscopic image may have mutable internal features, such as ultrasound-recorded changes in blood flow, etc. Stereoscopic microcosm 827 can also be rotated by gestures from the user, because the mobile virtual reality projection system is sensitive to the position, orientation and rotation of the projector. Other sorts of control interfaces such as buttons or voice recognition technology may also affect the appearance of stereoscopic microcosm 827. In some embodiments, motion sensitive probe 829 can also interact with stereoscopic microcosm 827. In these cases, motion sensitive probe 829 communicates with 3D environment builder 230, described above with reference to previous figures.

Stereoscopic microcosm 827 may also be supplemented by acoustical, tactile or other outputs from mobile virtual reality projection apparatus 500. For example, when stereoscopic microcosm 827 represents a beating heart, the visual projection may be supplemented by recorded or simulated sounds captured by a stethoscope. Such an application would find utility in medical education and in patient education. Many similar applications with utility in industrial design, microbiology, material science, etc. are possible with stereoscopic microcosm 827. All of these small-scale applications may also be converted to large-scale applications in the sensorium 721 (FIG. 7), and vice-versa. Thus, for example, a doctor may plan a heart surgery from within a simulation of the heart, as well as outside the heart, looking in. Many other similar multi-sensory simulations are possible with mobile virtual reality projection apparatus 500.

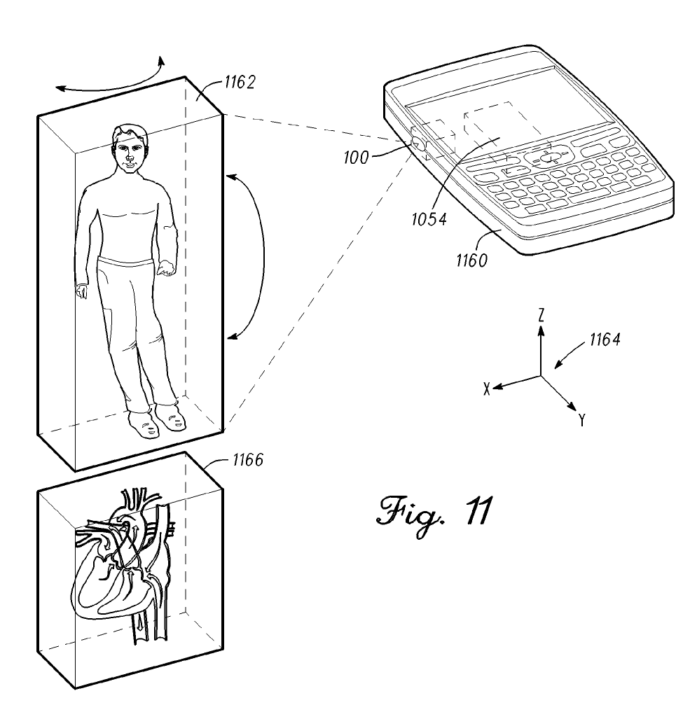

FIG. 9 shows a mobile virtual reality projection gaming apparatus. Gaming apparatus 940 allows a user or users to observe or interact with stereoscopic sensorium 721 (FIG. 7). The sensorium is navigated based on the motion, position or orientation of gaming apparatus 940, an apparatus that includes stereoscopic projector 102. Other control interfaces, such as manually-operated buttons, foot pedals, or verbal commands, may also contribute to navigation around, or interaction with the sensorium. For example, in some embodiments, trigger 942 contributes to the illusion that the user or users are in a first person perspective video game environment, commonly known as a “first person shooter game.” Because stereoscopic projector 102 offers binocular cues to the user, because it supports natural human equilibrium, and because sensorium 721 is a spherical, unbounded environment, gaming apparatus 940 creates a highly believable or “immersive” environment for these users.

Many other first person perspective simulations can also be created by gaming apparatus 940, for such activities as 3D seismic geo-prospecting, spacewalk planning, jungle canopy exploration, automobile safety instruction, medical education, etc. In all these simulation environments, interactions between the user and the sensorium can be mediated by tactile interface 944. Tactile interface 944 may provide a variety of output signals, such as recoil, vibration, shake, rumble, etc. Tactile interface 944 may also include a touch-sensitive input feature, such as a touch sensitive display screen or a display screen that requires a stylus. Additional tactile interfaces, for example, input and/or output features for motion sensitive probe 829 (FIG. 8), are also envisioned for use in various embodiments of the present invention.

Gaming apparatus 940 may also include audio output devices, such as integrated audio speakers, remote speakers, or headphones. These sorts of audio output devices may be connected to gaming apparatus 940 with wires or through a wireless technology. For example, wireless headphones 946 provide the user with sound effects via a Bluetooth connection, although any sort of similar wireless technology could be substituted freely. In some embodiments, wireless headphones 946 are integrated with decoding optics 510 (FIG. 5). In other embodiments, wireless headphones 946 may include microphone 945 or binaural microphone 947, to allow multiple users, instructors, or observers to communicate. Binaural microphone 947 typically includes microphones on each ear piece, to capture sounds modified by the user's head shadow. This feature is important for binaural hearing and sound localization by other simulation participants.

Gaming apparatus 940 may include any number of sensors 104 that measure motion, position and/or orientation. Virtual reality builder 206 or synthetic environment builder 230 are sensitive to these changes in motion, position or orientation, and adjust the stereoscopic image from projector 102 as necessary. For example, gaming apparatus 940 may detect absolute heading with a digital compass, and detect relative motion with an x-y-z gyroscope or accelerometer. In some embodiments, gaming apparatus 940 also includes a second accelerometer or gyroscope to detect the relative orientation of the device, or its rapid acceleration or deceleration. In other embodiments, gaming apparatus 940 may include a Global Positioning Satellite (GPS) sensor, to detect absolute position as the user travels in terrestrial space. Positional data may also be captured by means of external sensors 208.

Gaming apparatus 940 may include battery 941 and/or diagnostic lights 943. For example, battery 941 may be a rechargeable battery, and diagnostic lights 943 could indicate the current charge of the battery. In another example, battery 941 may be a removable battery clip, and gaming apparatus 940 may have an additional battery, electrical capacitor or super-capacitor to allow for continued operation of the apparatus while the discharged battery is replaced with a charged battery. In other embodiments, diagnostic lights 943 can inform the user or a service technician about the status of the electronic components included within or connected to this device. For example, the strength of a wireless signal received, or the presence or absence of a memory card. Diagnostic lights 943 could also be replaced by any small screen, such as an organic light emitting diode or liquid crystal display screen. Such lights or screens could be on the exterior surface of gaming apparatus 940, or below the surface, if the shell for this apparatus is translucent or transparent.

Other components of gaming apparatus 940 may be removable, detachable or separable from this device. For example, the mobile virtual reality projection apparatus may be detachable or separable from gaming housing 949. In some embodiments, the subcomponents of the mobile virtual reality projection apparatus may be detachable or separable from gaming housing 849, and still function. For example, stereoscopic projector 102, motion sensors 104, and/or external sensors 208 may function independent of gaming housing 949. But when these components or sub-components are assembled properly, the result is gaming apparatus 940.

FIG. 10 shows a mobile virtual reality projection apparatus used as an aid to navigation. Navigational apparatus 1050 is any mobile device that includes virtual reality projection apparatus 100, which by definition includes the ability to measure and display stereoscopic images based on the absolute or relative position, orientation or motion of the device. In this embodiment, stereoscopic images displayed by mobile virtual reality projection apparatus 100 help guide a user through real or virtual space. For example, terrain image 1056 is a three dimensional seismic map showing a target vein of ore. Moving navigational apparatus 1050 reveals this same bed of ore from different perspectives, for aid in placing drilling equipment, or guiding a drill bit in real time. Also for example, city map image 1058 shows a bird's eye view of a series of buildings rendered in three dimensions. City map image 1058 also shows the route one needs to follow to reach a set destination. By moving or manipulating other controls on navigational apparatus 1050, a user can affect the orientation or scale of city map image 1058. City map image 1058 may also be updated based on the absolute position of the user, with respect to global positioning system (GPS) satellites, etc.

Modern electronic land navigation devices are so tiny and power efficient that they are increasingly placed inside mobile electronic communications devices, such as cell phones or smart phones. Other mobile, wireless devices such as microcomputers or personal digital assistants (PDAs) may also easily accommodate these land navigational technologies: GPS chips, digital compasses, and the like. A wired or wireless connection therefore allows navigational apparatus 1050 to communicate with other networked electronic devices. For example, the location of other hikers could be transmitted and displayed across terrain image 1056, or current activities in building “A” could be transmitted and displayed within city map image 1058.

A wired or wireless connection also allows bilateral communication between navigational apparatus 1050 and other networked devices, and their users. For example, stereoscopic image capture devices 1052 could be two CMOS or CCD camera chips set apart from each other at human inter-ocular distance, to capture two still photographs or two streams of video data in stereoscopic relief. Many other technologies that allow stereoscopic image capture may be freely substituted here, including one or multiple electronic compound eyes, a larger array of photo-detectors, and the like. Such stereoscopic image capture devices 1052 allow navigational apparatus 1050 to function as a bilateral stereoscopic communication device. For example, the user of navigational apparatus 1050 could show other distant users a three dimensional image of a leaky pipe within a maze of pipes at an oil refinery. At another node in this shared network, another user could show the first user how to make repairs, using another stereoscopic camera system, or by using a graphical program with the ability to craft stereoscopic images. Thus stereoscopic image capture devices 1052 and mobile virtual reality projection apparatus 100 can communicate with other devices to display virtual, synthetic or real world images.

Navigational apparatus 1050 may also include audio capture and audio emission capabilities, provided by such components as microphones and speakers. In some embodiments, navigational apparatus 1050 includes binaural microphones 947. Binaural microphones 947 may be included within the same housing as mobile virtual reality projection apparatus 100. Alternatively, binaural microphones 947 may be connected by wired or wireless means, such as on a headset that also includes stereophonic speakers 946, and optional voice microphone 945. The addition of binaural microphones and stereophonic speakers allows dual-channel audio capabilities to supplement and enhance the stereoscopic capabilities of mobile virtual reality projection apparatus 100 and stereoscopic image capture devices 1052, to allow highly credible virtual realities, synthetic realities, or high fidelity re-creations of the real world. Optional force feedback module 1054 also brings human tactile senses into play, to help deliver virtual or synthetic user experiences that are veritably indistinguishable from real experiences.

Navigational apparatus 1050 may be a hand-held device or it may be attached to or worn on the user's body. For example, navigational apparatus 1050 may be part of a hat, headband or helmet. Alternatively, navigational apparatus 1050 may be mounted onto another device, such as a backpack, a flashlight, or a vehicle. In other embodiments, navigational apparatus 1050 is fully contained inside a cell phone, smart phone, PDA or mobile computer. In still other embodiments, navigational apparatus 1050 includes discrete components connected via wires or wireless means, such as a headset 946, or a force feedback module 1054 worn as a glove. These and many other component arrangements are possible. Overall, FIG. 10 and its description disclose how a mobile virtual reality projection apparatus acts in reception and reception/transmission modes to aid navigation, communication and other location-based services, including mobile advertising.

FIG. 11 shows a mobile virtual reality projection system used as a medical information device. Medical information device 1160 may be wired or wireless, equipped with fixed or removable memory, etc. For example, medical information device 1160 could be a so-called “personal digital assistant” (PDA) device connected to a hospital's network via a Bluetooth wireless connection. Many other comparable devices could be substituted freely here, including a cellular telephone or smart phone, wireless minicomputer, etc. The key additional component is a mobile virtual reality projection apparatus 100, one that is sensitive to the motion, orientation or location of medical information device 1160.

There are no limits to the type of data that medical information device 1160 can create, receive, store, or transmit. However, data that is formatted for stereoscopic display has the most utility in such embodiments.

Stereoscopic data is now common in advanced medical and scientific practice. Medical imaging devices such as positron emission tomography, nuclear magnetic resonance imaging, ultrasound, intravenous ultrasound and computerized axial tomography (also known as a “CAT” scan) often have 3-D display modes. Image-guided surgeries such as laparoscopic or endoscopic surgeries also may employ stereoscopic or auto-stereoscopic fixed displays. In addition, so-called robotic surgical equipment uses two monitors, with one display dedicated to each eye for the remote surgeon. In laboratory and hospital pathology, stereoscopic microscopy aids in identifying parasites, bacteria and viruses. Plus, computer-generated three dimensional graphics aid scientists in exploring molecules, elements, and sub-atomic particles: for example, in protein folding.

Such stereoscopic imagery offers three advantages to medical and scientific professionals, as well as the people they serve. First, stereoscopic perception benefits such as binary summation and depth perception mean that more information is available when an observer's two eyes look at a static data set from their separate visual perspectives. Second, if this displayed data is in motion, relative motion parallax and other motion-sensing perceptual and cognitive skills supplement the stereoscopic advantage to viewing static images. Third, if a human observer interacts with this data, for example, by manipulating a laparoscopic instrument, the stereoscopic benefits to hand-eye coordination also apply. Thus, stereoscopic displays improve medical and scientific practice. Conversely, not using stereoscopic display technology leaves behind a growing store of available and useful medical data, which may affect medical liability.

A mobile virtual reality projection apparatus 100 as part of medical information device 1160 has clear utility for users with respect to fixed stereoscopic or auto-stereoscopic displays. For example, medical information device 1160 is potentially hand-portable, and pocket-sized. Using this example, hospital medical staff could take one stereoscopic device from room to room, for diagnostic, student training or patient educational purposes. This reduces hospital costs, and improves training, education, and care.

In addition, mobile virtual reality projection apparatus 100 is sensitive to the motion, orientation and/or location of medical information device 1160. Therefore, intentional changes in these coordinates or vectors can change the data displayed, as previously noted. For example, a 3-D CAT scan of a patient's body 1162 can be displayed from multiple perspectives, including acute and oblique angles, to better diagnose medical conditions or to plan surgeries. Such 3-D medical images includes depth, height and width data that can be vectored through X, Y and Z axes 1164 to be displayed at actual size, or at any magnification or miniaturization. These displayed images may be considered as part of a macrocosmic sensorium, as described with reference to FIG. 7, or as part of a microcosm, as described with reference to FIG. 8. Furthermore, because the data is displayed by a projector, it is important to note that surgical teams and/or patients and their families can view the images together.

The binocular experience provided by medical information device 1160 is further improved using multimodal sensory inputs, such as sound or touch. For example, a stereoscopic image of a patient's heart 1166 may be enriched by auscultation data from digital stethoscopes or simulated stethoscopes. Such sound data may also be re-positioned through X, Y and Z axes 1164 in coordination with medical information device 1160. Also for example, incorporating optional force feedback module 1054 gives additional hand-eye coordination benefits to the user. This is relevant for planning mechanically assisted surgeries, especially when other training or surgical tools may include similar force feedback features. Optional force feedback module 1054 may also be located remotely, such as in a virtual reality glove, as described in FIG. 10.

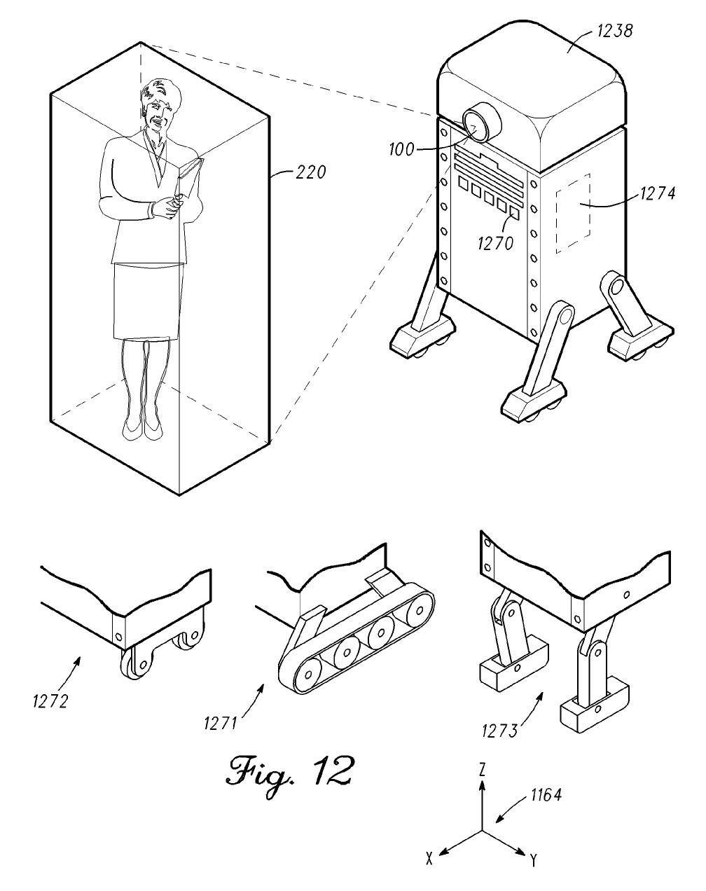

FIG. 12 shows a vehicular mobile virtual reality projection apparatus. Mobile virtual reality projection apparatus 100 may be carried onto or within, or mounted or temporarily mounted onto or within any sort of vehicle, including an automobile, truck, military vehicle, aircraft, boat, ship, space craft, etc. For example, mobile virtual reality projection apparatus 100 may be attached to the outer shell of robot 1238. Robot 1238 may be an autonomous device, or it may be remotely or directly controlled. Robot 1238 may include tracks 1271, wheels 1272, equipped with artificial limbs 1273, or use any other means of locomotion, including the capability for submerged locomotion, or for flight. As robot 1238 moves, mobile virtual reality projection apparatus 100 is sensitive to this motion, and has the ability to adjust the stereoscopic images displayed in accordance with the position, orientation, speed or acceleration of robot 1238.

Note that the ability of mobile virtual reality projection apparatus 100 to sense motion also allows it to disregard some motion inputs, such as common motion. For example, this common motion may relate to movement of a larger vehicle or vessel that mobile virtual reality projection apparatus 100 is aboard. With this ability to disregard common motion, virtual reality or synthetic reality simulations may be generated within larger vessels, without regard to the speed or heading of the vessel. Also for example, some spatial or motion data collected by mobile virtual reality projection apparatus 100 may be disregarded, whereas other spatial or motion data may affect the stereoscopic images displayed. Specifically, this applies to robot 1238, which includes mobile virtual reality projection apparatus 100.

Robot 1238 is also capable of generating synthetic realities, because it is equipped with an array of external sensors 1270 capable of recognizing subjects, structures and/or objects in the physical world. For example, sensor array 1270 could be a cluster of digital cameras or digital video recorders, photo-detectors, directional microphones, etc. Furthermore, if sensor array 1270 spanned farther than human inter-ocular distance, and/or human inter-aural distance, then the stereoscopic image displayed in 3D image cube 320 could be a hyper-stereoscopic image. Such hyper-stereoscopic image capture techniques are useful for penetrating visual camouflage. In addition, hyperstereopsis mimics the sensory capabilities of very large predators, such as polar bears, Ligers, or Tyrannosaurus Rexes. This is useful in the scientific fields of biology and paleontology.

Robot 1238 can display hyper-stereoscopic images using mobile virtual reality projection apparatus 100. In some embodiments, robot 1238 may include audio output device 1274, such as a speaker. This allows robot 1238 to present virtual reality images or synthetic reality images with accompanying sound tracks. According to the techniques and technologies described in the present invention, as robot 1238 moves through time and three dimensional space 1164, human observers can witness or participate in the virtual or synthetic realities that robot 1238 creates.

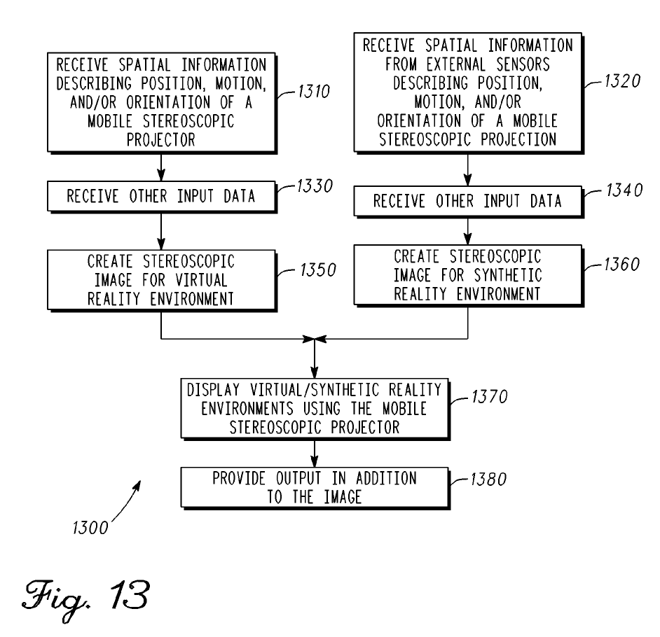

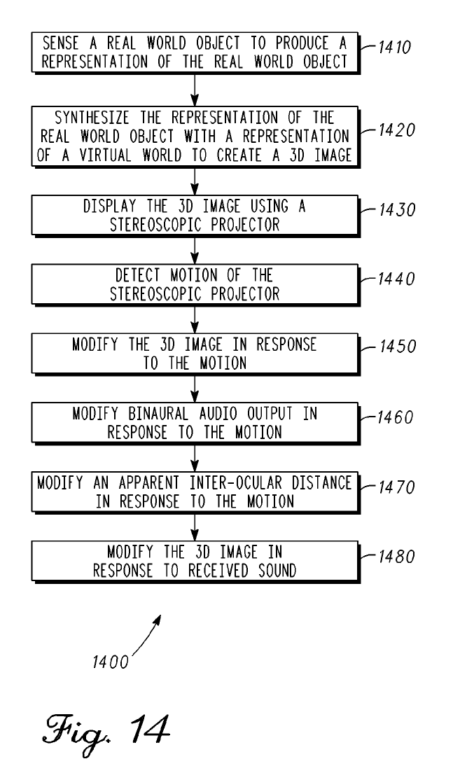

FIG. 13 shows a flowchart in accordance with various embodiments of the present invention. In some embodiments, method 1300, or portions thereof, is performed by a mobile stereoscopic projector, a spatially aware processor, or other spatially aware device, embodiments of which are shown in previous figures. In other embodiments, method 1300 is performed by an integrated circuit or an electronic system. Method 1300 is not limited by the particular type of apparatus performing the method. The various actions in method 1300 may be performed in the order presented, or may be performed in a different order. Further, in some embodiments, some actions listed in FIG. 13 are omitted from method 1300.

Method 1300 is shown beginning with block 1310 in which spatial information is received describing position, motion and/or orientation of a mobile stereoscopic or auto-stereoscopic projector. The spatial information may be received from sensors co-located with the mobile projector, or may be received on a data link. For example, spatial information may be received from gyroscopes, accelerometers, digital compasses, GPS receivers or any other sensors co-located with the mobile stereoscopic projector. Also for example, spatial information may be received on a wireless or wired link from devices external to the mobile stereoscopic projector.

In some embodiments, method 1300 begins with block 1320 instead of block 1310. At 1320, spatial information is collected via external sensors in order to describe the position, motion, and/or orientation of a mobile stereoscopic or auto-stereoscopic projector. These external sensors may be co-located with the mobile projector, or may transmit their information via a data link. For example, spatial information may be collected from remote sensing devices that are co-located with the stereoscopic projector, such as digital cameras, video cameras, laser range finders, lidar, radar, sonar, thermal sensors, or similar remote sensing technologies. Also for example, spatial information may be collected by similar remote sensing devices external to the mobile stereoscopic projector system that are connected to the system via a wireless or wired link.

At 1330 and 1340, other input data is received. “Other input data” refers to any data other than spatial information. For example, a user may input data through buttons, thumbwheels, voice, other sound, or by any other means. Also for example, data may be provided by other spatially aware mobile stereoscopic projector systems, or may be provided by a gaming console or computer. Note that 1330 and 1340 are shown in parallel in method 1300. Step 1330 includes non-spatial data inputs informing the creation of a stereoscopic image for a virtual reality environment, generated at step 1350. Step 1340 includes non-spatial data inputs informing the creation of a stereoscopic image for a synthetic reality environment, generated at step 1360. Steps 1330 and 1340 of method 1300 are otherwise identical.

At 1350, a stereoscopic image to be projected is generated or modified based at least in part on the spatial information. For example, the stereoscopic image may represent a first person binocular perspective in a virtual reality simulation environment, or it may represent 3D medical information relating to an anatomic or physiologic condition. As the mobile stereoscopic projector is moved, the image may respond appropriately. The image may be generated or modified based on the other input data in addition to, or in lieu of, the spatial information.

At 1360, a stereoscopic image to be projected is generated or modified based at least in part on the motion, position, or orientation of the projector with respect to a remotely sensed environment. For example, the stereoscopic image may represent a first person binocular perspective in a synthetic reality environment, where real world subjects, structures and objects may also influence the simulation. As the mobile stereoscopic projector is moved, the image may respond appropriately. The image may be generated or modified based on the other input data in addition to, or in lieu of, the spatial information.

At 1370, the virtual reality environment and/or the synthetic reality environment are displayed using the mobile stereoscopic projector. At 1380, output in addition to image modification is provided. For example, additional output in the form of sound, including binaural sound, or in the form of tactile force feedback (haptics) may be provided as described above. Any type of additional output may be provided without departing from the scope of the present invention.

FIG. 14 shows a flowchart in accordance with various embodiments of the present invention. In some embodiments, method 1400, or portions thereof, is performed by a mobile stereoscopic projector, a spatially aware processor, or other spatially aware device, embodiments of which are shown in previous figures. In other embodiments, method 1400 is performed by an integrated circuit or an electronic system. Method 1400 is not limited by the particular type of apparatus performing the method. The various actions in method 1400 may be performed in the order presented, or may be performed in a different order. Further, in some embodiments, some actions listed in FIG. 14 are omitted from method 1400.

Method 1400 is shown beginning with block 1410 in which a real world object is sensed to produce a representation of the real world object. At 1420, the representation of the real world object is synthesized with a representation of a virtual world to create a 3D image. At 1430, the 3D image is displayed by a stereoscopic projector.

At 1440, motion of the stereoscopic projector is detected. This may be performed with any suitable device, including but not limited to, an accelerometer, a GPS receiver, or the like. At 1450, the 3D image is modified in response to the detected motion. This may involve panning, zooming, translating, or any other change to the image.

At 1460, a binaural audio output is modified in response to the motion. For example, a user may be wearing binaural headphones, and a stereo audio output directed to the headphones may be modified to reflect movement of the user's head. At 1470, an apparent inter-ocular distance is modified in response to the motion. Based on the motion of the stereoscopic projector, the apparent inter-ocular distance may be increased or decreased. At 1480, the 3D image is modified based on received sound.

Although the present invention has been described in conjunction with certain embodiments, it is to be understood that modifications and variations may be resorted to without departing from the spirit and scope of the invention as those skilled in the art readily understand. Such modifications and variations are considered to be within the scope of the invention and the appended claims.

What is claimed is:

1. An apparatus comprising:
a stereo projection apparatus to produce left and right display images that when combined produce a stereoscopic image; and
a spatially aware processing device to cause the stereo projection apparatus to change the stereoscopic image based at least in part on movement of the stereo projection apparatus.

2. The apparatus of claim 1 further comprising at least one sound output device responsive to the spatially aware processing device.

3. The apparatus of claim 2 wherein the at least one sound output device comprises a stereo output device, and the spatially aware processing device is operable to modify sound produced by the stereo output device in response to the movement of the stereo projection apparatus.

4. The apparatus of claim 1 wherein the spatially aware processing device is operable to modify an apparent inter-ocular distance between the left and right display images.

5. The apparatus of claim 1 further comprising at least one sensor to provide a representation of a real world object, and wherein the spatially aware processing device is operable to synthesize the representation of the real world object with a virtual world to produce the first and second display images.

6. The apparatus of claim 1 wherein the stereo projection apparatus comprises a micro-electrical mechanical system (MEMS) mirror.

7. The apparatus of claim 1 wherein the stereo projection apparatus comprises two projectors with polarized outputs.

8. The apparatus of claim 7 wherein the two projectors are operable to produce circularly polarized outputs.

9. A projection display apparatus comprising:
at least one sensor to sense a real world object and to provide a real world object representation;
a data source to provide a virtual world representation;
a motion sensor;
a processing element to synthesize the real world object representation and the virtual world representation in response to the motion sensor; and
a three-dimensional (3D) projection apparatus to display a 3D image provided by the processing element.

10. The projection display apparatus of claim 9 wherein the 3D projection apparatus comprises a micro-electrical mechanical system (MEMS) mirror.

11. The projection display apparatus of claim 9 wherein the 3D projection apparatus comprises two projectors with polarized outputs.

12. The projection display apparatus of claim 11 wherein the two projectors are operable to produce circularly polarized outputs.

13. The projection display apparatus of claim 11 wherein the processing element is operable to modify an apparent inter-ocular distance between images produced by the two projectors.

14. The projection display apparatus of claim 9 further comprising at least one sound input device, wherein the processing element is operable to modify the 3D image based on received sound.

15. The projection display apparatus of claim 9 further comprising a stereo sound output device, wherein the processing element is operable to modify a stereo sound output based on information received from the motion sensor.

16. A method comprising:
detecting motion of a projector displaying a three dimensional (3D) image; and
modifying the 3D image in response to the motion.

17. The method of claim 16 further comprising modifying a binaural audio output in response to the motion.

18. The method of claim 16 further comprising:
sensing a real world object to produce a representation of the real world object; and
synthesizing the representation of the real world object with a representation of a virtual world to create the 3D image.

19. The method of claim 16 further comprising modifying an apparent inter-ocular distance used to generate the 3D image.

20. The method of claim 16 further comprising providing tactile force feedback in response to the motion.

21. The method of claim 16 further comprising modifying the 3D image based on received sound.
